(19) United States
(12) Patent Application Publication
(10) Pub. No.: US 2011/0201238 A1
(43) Pub. Date: Aug. 18, 2011

(54) Electric Powered Surfboard Propulsion and Control Systems

(75) Inventors: Dainuri Rott, Palo Alto, CA (US); Merrill Snell, Palo Alto, CA (US); Jos Goble, Santa Clara, CA (US); Daniel Fukuba, Palo Alto, CA (US); Cameron Tacklind, Menlo Park, CA (US)

(73) Assignee: WAVEDRIVE SYSTEMS, INC., Redwood City, CA (US)

(21) Appl. No.: 13/026,317

(22) Filed: Feb. 14, 2011

Related U.S. Application Data
(60) Provisional application No. 61/304,405, filed on Feb. 13, 2010.

(51) Int. Cl. B63H 21/17; B60L 11/00; G08C 19/12

(52) U.S. Cl. 440/6; 340/13.25

(57) ABSTRACT

Practical electric-powered propulsion systems, associated operator-control systems, and modification methods enable conventional surfboards (and similar small watercraft) to be converted for water-jet propulsion. Wireless controls are integrated with wearable marine accessories such as modified neoprene or fabric gloves, armbands, wristbands, hand straps, or gauntlets. Safely immersible, wet-swappable high-power battery packs facilitate extended use of electric propulsion in surf. Compact integrated electronic control units incorporate motor controllers, wireless receivers, and control logic. On-board power, propulsion, and control components are positioned and installed to avoid disrupting the shape of the watercraft body so as to minimize added hydrodynamic drag and perceived differences from a traditional unpowered version of the watercraft in appearance, balance, or performance. Components are designed to facilitate efficient installation using construction techniques already in widespread use among manufacturers and customizers of the analogous unpowered watercraft.

### RELATED APPLICATIONS

Priority benefit is claimed from U.S. Provisional Pat. App. No. 61/304,405, filed 13 Feb. 2010. Another related application is U.S. Provisional Pat. App. No. 61/147,733 filed 27 Jan. 2009.

### FEDERALLY SPONSORED RESEARCH AND DEVELOPMENT

None

### APPENDICES

None

### BACKGROUND

Relevant fields include electric-powered surfboards and electric-powered versions of other watercraft for which light weight, balance, and hydrodynamic shape are critical factors in performance.

Internal-combustion-powered motorized surfboards have been built at least as far back as 1950, as a “self-propelled surfboard” appeared on the cover of the April 1950 issue of Mechanix Illustrated. This device used a 7.5 hp outboard engine in a large front-mounted engine housing and was not used for conventional wave surfing but rather for an alternative, high-speed jet-ski-like experience. Edward Dawson patented a powered board propelled by a rear-mounted gasoline engine in August 1969 (U.S. Pat. No. 3,463,116) which attempted to reduce the size and visual impact of the engine compartment. Another gasoline powered surfboard, with an engine mounted entirely inside the body of the surfboard, was produced during the late 1960s, with related U.S. Pat. No. 3,262,413 issuing to Douglas, Bloomingdale et al. in July 1966. This was an aluminum-hull surfboard containing a chainsaw-type engine entirely contained in an internal compartment, using water-jet propulsion and foot-operated controls. In appearance it was much closer to conventional surfboards and it could be ridden in a standing position.

All of these gasoline-powered boards shared similar drawbacks: noise, smoke, weight, expense, danger to operators and environment posed by potential fuel leaks, and appearance and performance characteristics unlike those which surfers expected from conventional boards. Since the 1960s combustion-driven powered boards have continued to evolve into high-power, high-speed devices more akin to jet skis than to conventional surfboards in usage and intent. Though some were originally intended to mitigate the need for strenuous paddling to reach surf and catch waves, they never enjoyed widespread popularity or notable commercial success.

In August 1968 a newspaper article in the Worthington Daily Globe briefly described a battery-powered surfboard designed by a Fleischer Manufacturing Company of Salt Lake City using an electric propulsion motor custom-designed by George Wasko. Assembly of these motors and boards was said to be in progress A. F. Scheppmann and Son Manufacturing Co. of Okabena, Minn. and at Windom Manufacturing Co. The photograph published with the story appears to show an Okabena resident riding some sort of powered board on a lake, holding a wire presumably to control it. Other than this newspaper article, information about this product appears to be lacking in published sources. It was likely propeller-driven, rather than water-jet-driven, since the article refers to “tiny motors and propellers” (emphasis added). The absence of subsequent published information implies that this particular invention failed commercially, if indeed it ever came to market.

Further variants of electric-powered surfboards have also been conceived. Namanny (Pat. App. Pub. No. US20030167991, now abandoned) discloses a small electric-powered propeller unit mounted on a surfboard fin. Rum et al. (Pat. App. Pub. No. US20080168937, now abandoned, and previously issued U.S. Pat. No. 7,207,282) disclose a “propeller-driven surfing device” with an electric motor and power supply. Railey (Pat. App. Pub. No. US20080045096, and previously issued U.S. Pat. No. 7,226,329) discloses a surfboard with dual internal electric motors and impellers. Chang (U.S. Pat. No. 5,017,166) describes a DC-motor-powered board with a large rear propeller and foot-operated control. Jung (U.S. Pat. No. 6,702,634) powers a board with an electric motor controlled by switches on a steering column, driving a helical propeller and including a retractable “brake.” Efthymiou (U.S. Pat. No. 6,142,840) designed a board with a specialized shape and fin structure, dual water-jet pumps with angled intakes, and a wired handgrip control. Austin (U.S. Pat. No. 6,409,560) housed a motor in a box attached to the bottom of the board, with an external propeller and controls on a steering column.

As of this writing, none of these designs are in widespread use. Either the experience of riding them is not really “like” surfing, or the production cost renders them unaffordable for most surfers, or protruding parts create excessive drag, break easily, collect seaweed and other flotsam, or complicate transport. A motorized board that maneuvers like a traditional board, stands up to the physical punishment of heavy surf and frequent transport, takes advantage of the nuanced throttle control available with electric motors, is powerful enough to Obviate (or operate as) a tow craft at “tow-in” locations, with a long-lasting battery that can be swapped out in wet conditions and easily recharged, could be welcomed by the sporting-goods industry, particularly if the production costs are reduced enough to facilitate widely affordable prices.

### SUMMARY

An electric-powered water-jet propulsion system with wireless operator control facilitates safe, practical, effective, commercially viable motorization of surfboards and other small, balance-sensitive watercraft

Prior batteries typically encountered one or more obstacles to effective use in motorizing small balance-critical watercraft: They added excessive weight or drag-generating interruptions of hull surfaces, their capacity was insufficient for prolonged use, recharging was inconvenient, and replacement could not be done in the presence of water. The solution described here is a wet-swappable, high-power-density, high capacity, conveniently rechargeable battery pack with acceptable weight for even the shorter variety of surfboard.

Prior electric propulsion systems were subject to insufficient power, inefficient use of stored power, excessive weight, overheating, and the starting difficulties caused by trapped air around the impeller. Here, a compact internal water jet pump unit of acceptable weight includes an integrated high-performance electric motor efficiently cooled by the surrounding water jet flow and prompt passive venting of any trapped air whenever the watercraft enters the water.

Prior propulsion-control systems were overly fragile (on wires or stalks) or they required the operator to look down or change position (e.g. bringing the hands together), potentially compromising the balance of the operator and watercraft. Here, a wearable wireless controller is operable by small movements of the fingers or thumb of one hand without looking, freeing the operator to take any necessary or desired bodily position. The controller drives a compact control unit integrated in the body of the watercraft, including a wireless receiver and programmable control logic circuitry to take full advantage of the nuanced throttle control made possible by an electric motor. For instance, a software-controlled “soft” motor power-down prevents sudden unbalancing stops.

High cost and a “look and feel” significantly different from the esteemed traditional unpowered versions of the watercraft have hindered commercialization of prior systems. Here, all on-board power supply, propulsion, and electronics control components are installed within the board or hull, under covers faired into the watercraft's normal contours. Cost is controlled by using installation methods already established for traditional versions of the watercraft. For example, a commercial surfing longboard, (either a hard-shelled board or a soft-surface “foamie”) may be modified with electric water-jet propulsion using the same family of techniques already employed by surfers and board-builders to add fins in desired locations.

### BRIEF DESCRIPTION OF THE DRAWINGS

FIG. 1A is a cross section of the assembled jet pump casing showing the motor and impeller installed inside the casing.

FIG. 1B is an exploded view showing the integrated jet pump assembly with its associated jet pump shroud and cover plate.

FIG. 2 is an exploded view of a preferred embodiment of the wet-swappable battery pack.

FIG. 3 is an exploded view of a preferred embodiment of the battery pack receptacle with the assembled battery pack positioned for insertion into the receptacle.

FIG. 4A shows the electronic control unit (EGO cover plate and electronic components.

FIG. 4B is an exploded view of the ECU box.

FIG. 5 is a schematic exploded cross-section showing cavities and channels in the board body with installed tin-box-type liners and the corresponding power components ready for insertion.

FIG. 6 illustrates a preferred embodiment of a hand-operated wireless controller.

### DETAILED DESCRIPTION

A surfboard is possibly the smallest, lightest, and most balance-critical of the group of similar watercraft (canoes, kayaks, pirogues, windsurfers, etc.) Surfing is also probably the most demanding of “start and stop” motorization and nuanced throttle control; a surfer may turn on the motor to get through the zone of breaking and cresting waves, use fine throttle control to catch a wave, then turn off the motor while riding the wave. Air can be trapped near the motor not only in the transition from beach to water, but also when the surfer “catches air” going over a swell. Surfboards are routinely flung onto sand or rocks, so durability is a must. A surfer's whole body is engaged in balancing and maneuvering the board; if control of the motor requires looking down, reaching for something, or even bringing a hand to the body or both hands together could destabilize the board and cause a “wipeout.” The examples below are drawn to surfboards as a most-demanding-case, but minor modifications for other similar watercraft are within the scope of this invention.

The terms “fore” and “forward” are used to refer to positions relatively in the direction of the nose or bow (toward the direction of normal forward motion). The terms “rear” and “aft” are used to refer to positions relatively in the direction of the tail or stern (opposite to the direction of normal forward motion).

The components that combine to advance the art of motorized surfboards and similar watercraft include:

1. An integrated water jet pump assembly comprising a cylindrical electric motor, a rotor/impeller attached to the motor shaft, a stator with hydrodynamic flow-control vanes and integrated front motor mount, a motor tube with optimal clearance for the propulsion water jet to efficiently cool the motor, an exit cone section with streamlined radial vanes, integrated rear motor mount, and wiring conduits built into the vanes, and an outlet nozzle optimized to shape the water jet for efficient propulsion;

2. A jet-pump shroud containing the water jet pump assembly with a streamlined water-intake conduit forward of the impeller, a water outlet aft of the nozzle, a perimeter flange for fin-box-type installation, wiring ports, locating features for easy assembly, a vent hole on top to vent trapped air, and an interior shape that encourages bubbles toward the vent hole, and a cover plate contiguous with the bottom of the surfboard and perforated to allow adequate water intake white excluding seaweed and other debris;

3. A wet-swappable battery pack comprising along-lasting powerful battery cell or array of cells potted into a waterproof case, a pair of female power connectors recessed in the bottom of the case and sealed to prevent water from forming a conducting path between them, a sealed lid, integrated locking features that secure the pack in the board but are easily hand-released to swap batteries, and asymmetric features to prevent incorrect insertion;

4. A battery pack receptacle with latching features to securely hold the battery until an operator activates the hand-release apparatus, a pair of male power connectors that mate with the female connectors on the battery pack, and a perimeter flange for fin-box-type installation;

5. An electronic control unit (ECU) assembly comprising a wireless receiver, a motor controller, a microprocessor with programmable instruction storage, a mounting tray to anchor connectors, a tube to align and protect the receiver antenna, a waterproof ECU box with a perimeter flange for fin-box-type installation, and a sealed bottom cover designed to conduct waste heat away from the ECU and into the surrounding water;

6. A surfboard body of a conventional size and shape, modified with cavities on the fore-aft centerline for the battery pack (on top for easy swapping), the ECU box and the jet-pump shroud (on the bottom for conductive cooling and water intake, respectively) recessed so that, when the motorized board is fully assembled, the covers and the top surface of the battery are substantially flush with the surrounding board surface, placed to minimize the disturbance of the balance and center of gravity; further modified with wiring channels for the necessary connections and an air-vent tube leading from the air-vent hole in the pump shroud to the top surface of the board;

7. A wearable wireless controller with a trigger switch on the operator's hand operable by the thumb or fingers of the same hand without disturbing operator balance or concentration, an associated lightweight battery and wireless transmitter mounted nearby but out of the way (e.g., on the operator's forearm), configured for safety to run the motor only while the operator actively holds the switch in an “on” position;

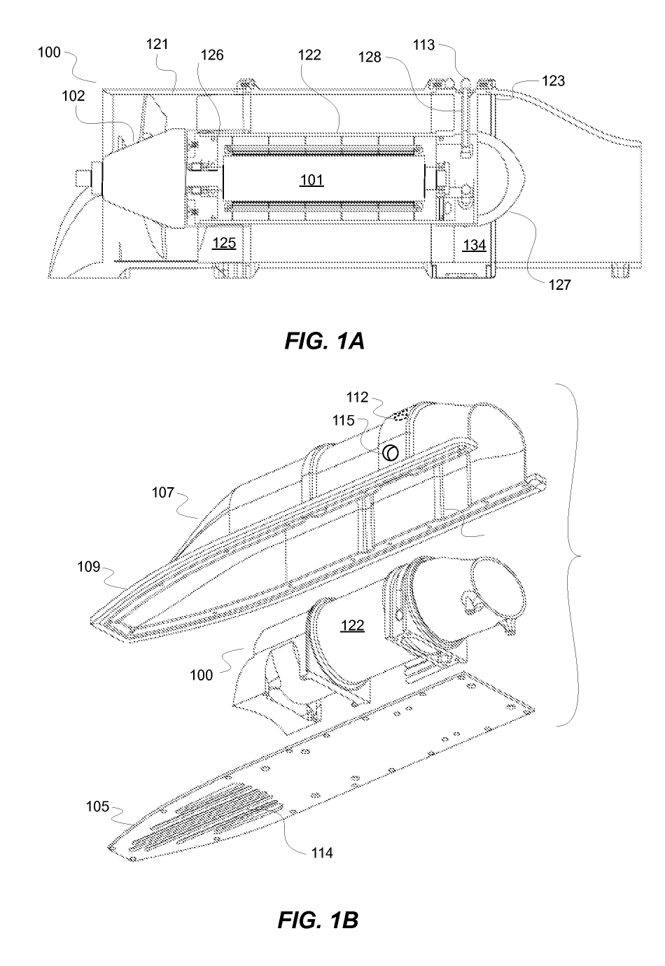

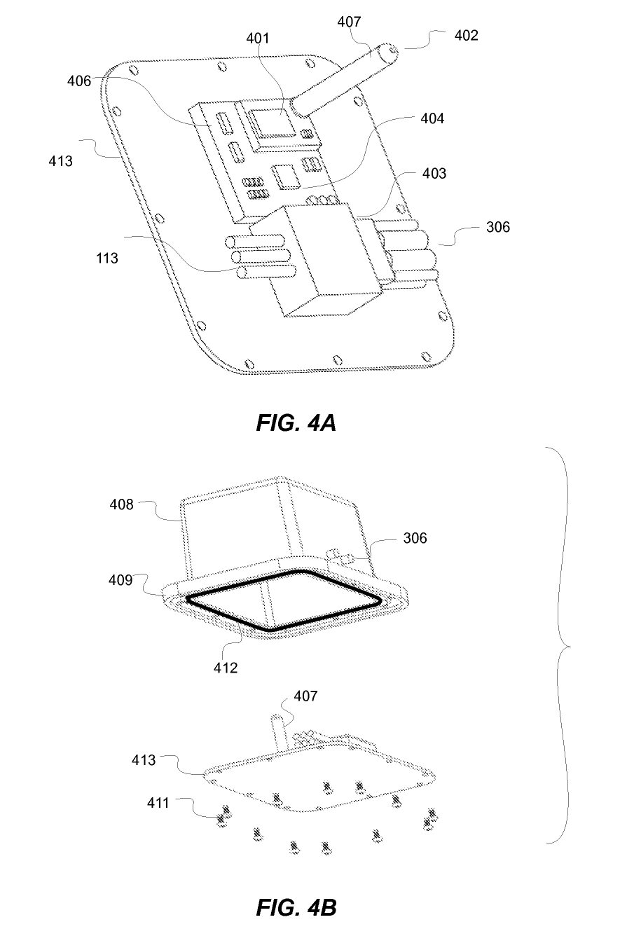

In FIG. 1A, a waterproof electric motor 101 (in this embodiment, a brushless DC electric motor of “inrunner” design) is installed in a sectional jet-pump casing forming integrated jet-pump assembly 100. The rotating shaft of motor 101 passes through forward motor mount 126 and multi-bladed impeller 102 (in this embodiment, a modified commercially available marine impeller) is attached to the end of the shaft. The impeller is thus positioned within stator section 121 forward of stator vanes 125, which redirect the water flow from the impeller. Motor 101 is secured in forward motor mount 126 by a balanced circular array of mounting fasteners (not shown). The cylindrical body of motor 101 extends rearward axially inside motor tube 122, with sufficient clearance between the outer casing of motor 101 and the inner wall of motor tube 122 to facilitate efficient conductive cooling of motor 101 by the water jet passing around it. The rear end of motor 101 preferably fits snugly inside the open forward end of exit cone 127, obviating the need for more mounting fasteners. Motor power leads 113 conduct current from the electronic control unit (ECU, see FIGS. 4A, 4B) to motor 101 via power lead passages 128 contained in exit cone vanes 134.

FIG. 1B is an exploded view showing the integrated jet pump assembly 100 with its associated jet pump shroud 107 and cover plate 105. Jet pump shroud 107 is an elongated, tapering, arched casing made of ABS (or some other suitable waterproof, substantially rigid material) to completely contain jet pump assembly 100. A streamlined forward portion forms an optimal water intake conduit just forward of impeller 102 (hidden by the intake casing in FIG. 1B). Jet pump shroud 107 is permanently installed into a conforming cavity in the lower rear surface of a surfboard body so that the outer perimeter of the attached jet pump shroud flange 109 is flush with the outer skin of the surfboard. The inner perimeter of jet pump shroud flange 109 is slightly recessed just sufficiently to accommodate the thickness of jet pump cover plate 105, which when installed is also substantially flush with the outer surface of the surfboard, minimizing added drag and substantially maintaining the normal contours of the surfboard. In this embodiment, cover plate 105 is made of anodized aluminum, but it could also be made of other sturdy rigid plastic, metal or composite material.

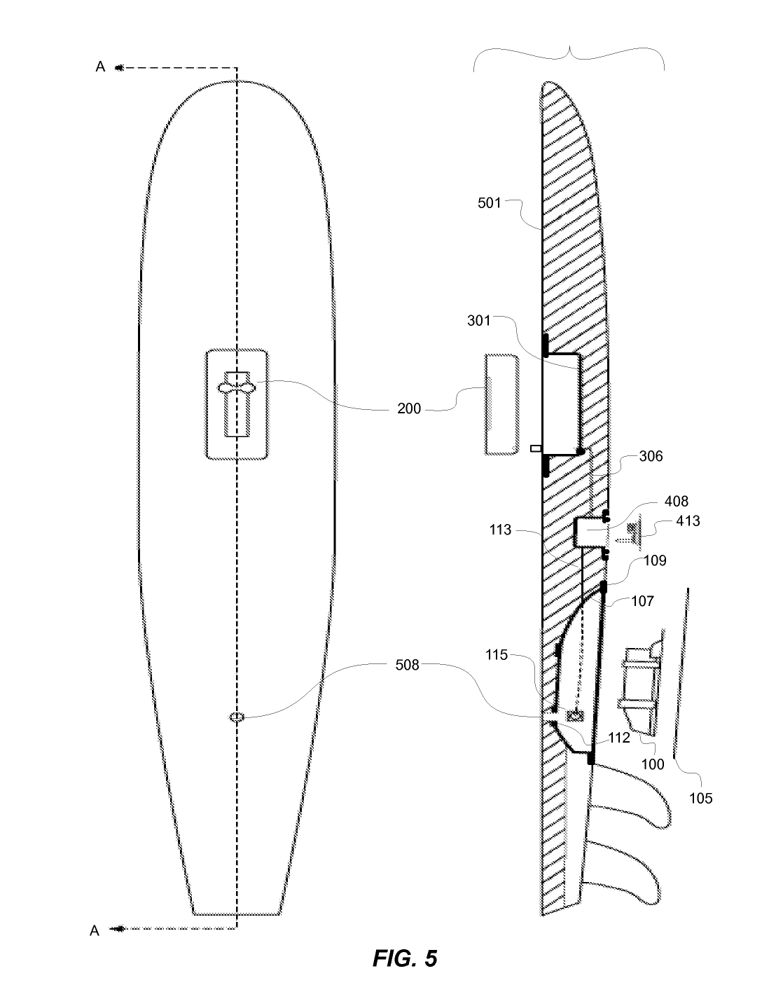

Jet pump shroud 107 also incorporates at least one air vent hole 112 located near the apex of the arched portion of the shroud. Internal jet-pump conduits in water-jet propulsion systems tend to trap air inside when first submerged. This trapped air can fully or partially surround the jet-pump impeller. When the jet pump is activated with air around the impeller, the impeller cannot create enough suction force to draw enough water into the intake to “prime” the pump. Air vent hole 112 allows such trapped air to quickly escape when the surfboard is first placed in the water or returns to the water after “catching air.” When the surfboard is in normal use, the apex of the shroud is its highest point Air bubbles in water naturally tend to rise. The smooth interior tapers and curves of the shroud guide rising bubbles toward the apex, expediting the venting of trapped air through air vent hole 112. From air vent hole 112, the air passes into an air vent tube (508 in FIG. 5) which leads upward through the body of the surfboard to an escape port in the board's top surface. Thus, any air bubbles in the jet-pump cavity escape harmlessly into the ambient air rather than remaining trapped in shroud 107 to interfere with the next attempt to start the motor.

Cover plate 105 incorporates an anti-fouling grate 114, comprising an array of water intake holes, slots or other openings in the forward portion of cover plate 105 of sufficient size to allow adequate intake of water through the openings into the forward intake portion of the enclosed integrated jet-pump assembly 100 when the motor is activated, but not large enough to admit substantial pieces of potentially pump-fouling material such as seaweed or other foreign material commonly found in surf zones.

To install the integrated jet-pump assembly 100 into the installed jet-pump shroud 107, motor power leads 113, which enter shroud 107 through motor power lead port 115, are inserted through power lead passages 128 in exit cone vanes 134, and mated to with motor power connectors in the rear motor end bell. Slack wire of motor power leads 113 is partially wrapped around the outer circumference of exit cone section 123 as necessary to avoid mechanical interference from leads 113 when integrated jet-pump assembly 100 is being installed into shroud 107. Next integrated jet-pump assembly 100 is placed into jet-pump shroud 107, where detents 108 or other locating features ensure correct and secure placement. Subsequently, cover plate 105 is secured to casing elements of integrated jet-pump assembly 100 with bolts or other suitable fasteners. Finally, the perimeter of cover plate 105 is secured to shroud flange 109, for example with bolts through perimeter holes into threaded holes or inserts in shroud flange 109.

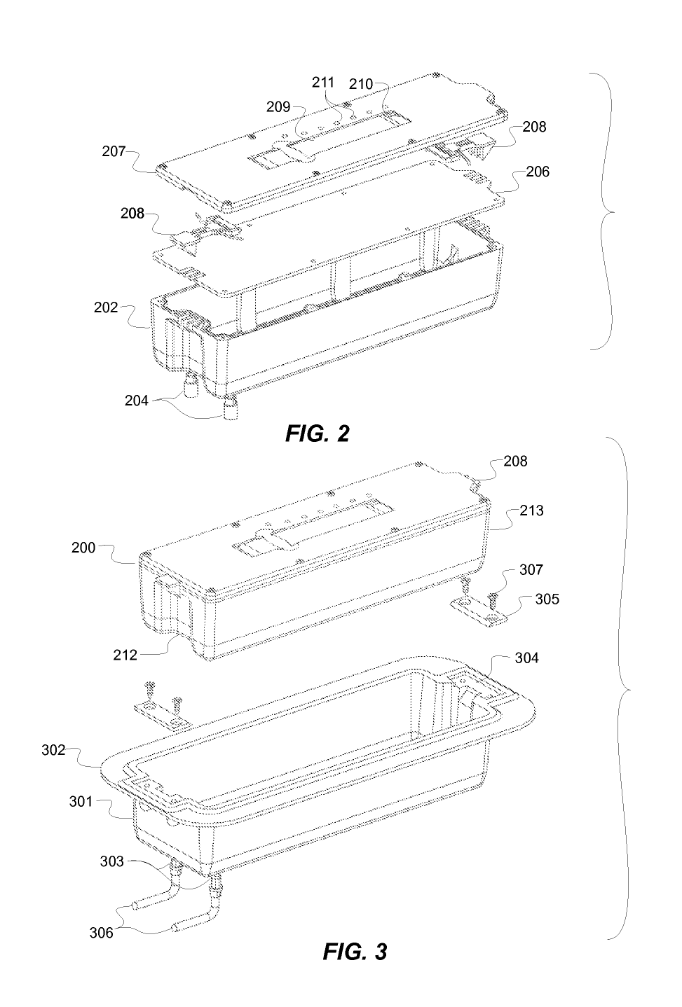

FIG. 2 is an exploded view of the wet-swappable battery pack that supplies power to the motor. A waterproof open-topped battery pack case 202, made of ABS plastic or other suitable rigid material, contains an array of parallel-connected groups of cells (not shown). Preferably, each group comprises several cells connected in series, and each parallel-connected group contains the same number and type of cells. Commercial lithium-ion nanoparticle-type cells have been shown to perform satisfactorily. The void space in the case is substantially filled with a suitable commercial waterproof potting compound (such as flexible urethane casting compound, or epoxy) encasing the cells and associated contacts and connections to protect them from moisture. Two electrical power terminals (“female bullet leads”) 204 connected to the array of cells are integrally recessed into the outer rear bottom surface of the case 202. Each recessed female terminal 204 has a waterproof seal, such as an O-ring, within its recess to isolate the terminals and prevent inter-terminal electrolysis in wet environments.

The bottom surface structure of lid 207 encloses two protruding spring-loaded locking pins 208, one protruding at each end of lid 207. Spring-loading in this embodiment is accomplished by a suitable spring steel wire arc or bow in the structure of each locking pin 208. This steel bow seats against structure in the bottom surface of lid 207, resisting retraction of locking pins 208 and exerting force to keep locking pins 208 extended outside lid 207.

Strap 209 is a thin flexible fiat band made preferably of a durable fabric that can tolerate extended salt water immersion and sun exposure. Each end of strap 209 is attached to one of the locking pins 208 so that the spring tension of locking pins 208 draws strap 209 substantially into a shallow recessed strap detent 210 in the upper surface of lid 207. Strap 209 normally lies in detent 210 substantially flush with the upper surface of lid 207, so it does not become snagged on passing objects or the operator's feet. However, when the operator grasps strap 209 and pulls firmly, the resulting tension retracts spring-loaded locking pins 208 to unlatch the battery pack from its receptacle (see FIG. 3).

Lid 207 also incorporates one or more small indicator holes 211 through its upper surface to allow for the visibility of one or more suitable visual indicators such as LED indicators) to visually indicate battery charge level, temperature, trouble status or other information to the operator above. When the battery pack is assembled, lid 207 preferably forms a waterproof seal with battery pack case 202. In the illustrated embodiment, the seal is created by compressing elastomeric gasket 206 in the process of tightening down lid 207.

FIG. 3 is an exploded view of a preferred embodiment of the battery pack receptacle with battery pack 200 ready for insertion. A flanged open-top waterproof box 301, made of ABS plastic or other suitable material, of shape and internal dimensions to create a running slip-fit with the swappable battery pack, is permanently installed into a conforming cavity cut in the upper central surface of a commercial surfboard body, so that the outer perimeter of integrated flange 302 which surrounds the top edges of box 301 is substantially flush with the outer skin of the surfboard. Positive and negative upwardly-protruding electrical power terminals (“male bullet leads”) 303 are installed in the inner bottom surface of the box 301, for contact-connection to the female terminals 204 in the outer bottom surface of the battery pack case 202. Battery power leads 306 are connected to male terminals 303 where they penetrate the underside of the box 301, Power leads 306 then run through holes drilled (or channels cut and filled) in the surfboard body, to connect to the electronic control unit (ECU).

Integrated flange 302 incorporates locking pin receiver recesses 304 at forward and rear positions, capped by locking pin receiver plates 305 that are secured by receiver plate screws 307. Recesses 304 and receiver plates 305 form receivers for spring-loaded battery pack locking pins 208. When the assembled battery pack 200 is inserted into the assembled battery pack receptacle with corresponding male and female terminals 303 and 204 fully connected, spring-loaded looking pins 208, extend into the locking pin receiver recesses 304 and are retained therein by the locking pin receiver plates 305, securing the battery in place.

Preferably, the battery pack has one or more asymmetrical features, such as keyway 212, configured to mate with corresponding asymmetric features in the battery pack receptacle such as a protrusion slip-fitting into keyway 212 (not visible in this view). Because the other end 213 of battery pack 200 has no keyway, the protrusion in the receptacle hinders attempts to insert the battery backwards. Because keyway 212 does not extend all the way to the top of battery pack 200, the protrusion also hinders attempts to insert the battery upside-down. This asymmetry ensures that battery pack electrical power terminals 204 (see FIG. 2) will always properly engage battery pack receptacle electrical power terminals 303, rather than risk mechanical crushing or reversed electrical polarity. Any suitable known mechanical-asymmetry features may be used.

A battery pack may also incorporate one or more flotation chambers permanently enclosing air voids, foam material, or other buoyant matter sufficient to float the battery pack if it should fall overboard. Visibility aids such as fluorescent or phosphorescent exteriors could facilitate location and retrieval of floating batteries in rough or cloudy waters. In another embodiment, the battery pack may be cylindrical rather than prismatic in shape. In still another embodiment, the battery pack may advantageously incorporate one or more supercapacitors or inductors besides, or instead of, battery cells.

Other advantageous embodiments may include two or more battery packs and two or more battery pack receptacles, thereby supporting higher jet-pump propulsion power levels, longer time-of-use for the jet-pump propulsion system, or both. Alternatively, the extra receptacle(s) could be without electrical connections and used only to store extra batteries for mid-water swapping.

FIG. 4A illustrates the electronic control unit (ECU) electronics, comprising wireless receiver 401, antenna 402, programmable motor controller 403, and interface circuit 404 incorporating a microprocessor and a readable storage element (for instance, an EPROM) programmed with intelligent-motor-control firmware or software to exploit the nuanced control possibilities of electric motors. For example, when interface circuit 404 receives an “off” input from wireless receiver 401, it signals the motor controller 403 for a rapid series of incrementally reduced motor power levels, ending with zero motor power. This ramping procedure results in a “soft” power-down, which avoids destabilizing the surfer on the board with the sudden change in equilibrium that would result from a “hard,” instantaneous power shutoff. Other power level settings and power/time profiles may also be programmed in.

Another useful category of software or firmware for the ECU is by a data-recording function within the ECU; for example, wireless-communication data, motor performance data, or physical data from temperature, acceleration, pressure, speed, or electrical sensors mounted in the board. Analysis of the data could enable performance and quality analysis and engineering improvements. The recording function would provide experimental data for board designers and diagnostics for operators and repairers.

In alternate embodiments, the ECU is user-programmable via an interface port connected to, or a wireless transceiver communicating with, a computer or mobile device equipped with ECU-programming software. Such software may allow customized control of one or more motorized-surfboard propulsion or wireless-communication parameters (for example, time duration of “soft” motor power-down discussed above), access to recorded data, and adding recording functionality for later-installed sensors and other hardware.

All these components except the motor controller 403 are supported in ECU mounting tray 406 which incorporates locator holes or passages and connector plugs or terminals (e.g., bullet leads, not shown), for battery power leads 306 and motor power leads 113. Mounting tray 406 also incorporates an antenna receptacle 407 which maintains the antenna 402 in an optimal operating orientation (in this embodiment, pointing perpendicularly toward the top of the board). This antenna orientation optimizes reception of wireless signals from the operator's wireless controller. Motor controller 403 is mechanically secured in thermal contact to metal cover plate 413 (for example, by thermal epoxy). This arrangement allows heat from the motor controller 403 to be dissipated into the surrounding water when the surfboard is in use.

FIG. 4B is an exploded view of the waterproof electronic control unit (ECU box, comprising an open-top waterproof case 408 made of ABS plastic or other suitable waterproof rigid material, an integrated flange 409 around the perimeter of the open top (which, when mounted in this embodiment of a surfboard, becomes an open bottom), and a perimeter seal 412 (e.g., an O-ring or other waterproof gasket) mounted on flange 409. Case 408 is permanently installed in a conforming cavity cut in the tower surface of a surfboard body so that the outer perimeter of flange 409 is substantially flush with the outer surface of the surfboard. Battery power leads 306 and motor power leads 113 (not visible in this view) penetrate case 408 to connect to the ECU electronics to be housed inside; these case penetrations are seated and waterproofed. Motor power leads 113 extend from outside case 408 to jet-pump shroud 107 through holes drilled, or channels cut and tilled, in the surfboard body. Battery power leads 306 arrive from battery pack receptacle box 301 via similar holes or tilted channels

Mounting tray 406 with the associated electronic components, and motor controller 403 attached to heat-dissipating cover plate 413, are inserted into installed case 408 so that cover plate 413 fits onto flange 409 contacting seal 412. When cover plate 413 is tightened onto perimeter flange 409 (for example, by tightening perimeter fasteners 411 through fastener holes 414), seal 412 is compressed to create a watertight join. When secured, cover plate 413 will lie substantially flush with the outer surface of the surfboard, minimizing drag and maintaining the normal contours of the surfboard.

In another embodiment, all ECU electronics (such as the antenna, wireless receiver and interface circuit) are encased in a cast block of waterproof potting compound or plastic that may be installed directly into the surfboard body, eliminating the need for a separate ECU casing.

FIG. 5 is an exploded cross-section on section line A-A of a motorized surfboard assembly, showing the cavities and channels created in the board body and the components that fit into them. Surfboard body 501 has been modified with cavities in its bottom surface fitted to jet pump shroud 107 and, ECU box 408, and a cavity in its top surface fitted to battery pack receptacle case 301 Shroud 107, box 408 and case 301 are shown here with a fin-box-type design and installation. Assembled battery pack 200 is shown positioned for insertion in battery pack receptacle 300. Battery power leads 306 extend from battery pack receptacle case 301 to ECU box case 408 through internal holes or channels in surfboard body 501. Motor power leads 113 extend from ECU box case 408 to jet pump shroud 107 through internal holes or channels in surfboard body 501 and pass through power lead port 115. Air vent tube(s) 508 are shown in the rear portion of the top surface of surfboard body 501. Air vent tube(s) 508 extend through the surfboard body 501 from jet pump shroud air vent hole(s) 112 to the pierced top of the board. Integrated jet-pump assembly 100 is shown positioned for insertion in jet-pump shroud 107. After integrated jet-pump assembly 100 is inserted in jet-pump shroud 107, cover plate 105 is poised to be fastened to integrated jet-pump assembly 100 and jet-pump shroud flange 109. ECU cover plate 413 (with attached electrical components previously discussed) is ready for attachment to ECU box flange 409. After assembly, all the covers will become substantially continuous extensions of the surrounding surfaces of board body 501, resulting in minimal departure from the appearance, hydrodynamics, and ergonomics of a conventional surfboard.

While the preferred embodiment of the electric-powered motorized surfboard is implemented with a “longboard” type of surfboard, other advantageous embodiments may be implemented using other sizes and types of surfboard (for example lighter, shorter, higher-performance “short boards”, “knee boards”, or heavier “stand up paddle” boards) incorporating identical propulsion, control, and power supply components as those described above, or similar alternate components adapted to fit the shape, size, and weight of the alternate type of board used.

Jet pump shroud 107, battery-pack receptacle 301, and ECU box 408 may be included as part of a purpose-built motorized surfboard, but alternatively may be installed in an existing unpowered surfboard using “fin-box” modification techniques that are already standard among surfers and boardmakers. Fin boxes are after-market inserts, usually made of a hard plastic, with one or more slots to receive the stern of a fin and flanges around the perimeter of the slogs). To install a fin box, a suitable fitted cavity is created in the board using a router or the like. The cavity includes a step to position the top surface of the fin-box flange either flush with the board surface or slightly recessed, depending on the next steps. The cavity may then be lined with adhesive, fiberglass sheets, or both as appropriate to the particular material(s) and structure of the board. The fin box is affixed into the cavity. The box may then be “glassed” into the cavity (fiberglass sheets are laminated to the flange and the surrounding board area), or some other reinforcement method may be used. In all cases the end result is a reinforced slot permanently and durably embedded in the board, without significant drag-generating interruption of its surface shape and often elegantly harmonizing with the board's visual appearance. A fin locked into the slot is attached ruggedly enough to survive the shocks and stresses typical of use in heavy surf.

The pump shroud, ECU box, and battery-pack receptacle of the preferred embodiment can be retrofitted into existing surfboards using these well-known fin-box techniques because of the perimeter flanges and simple silhouettes. Those skilled in the art might expect this approach to seriously compromise the strength and useful life of the board; the cavities required here are significantly larger than those typical of fin-boxes, and incidents of even structurally intact boards being snapped in two by heavy surf are fairly common. However, prototype tests uncovered no such structural fragility even in notoriously challenging surf locations.

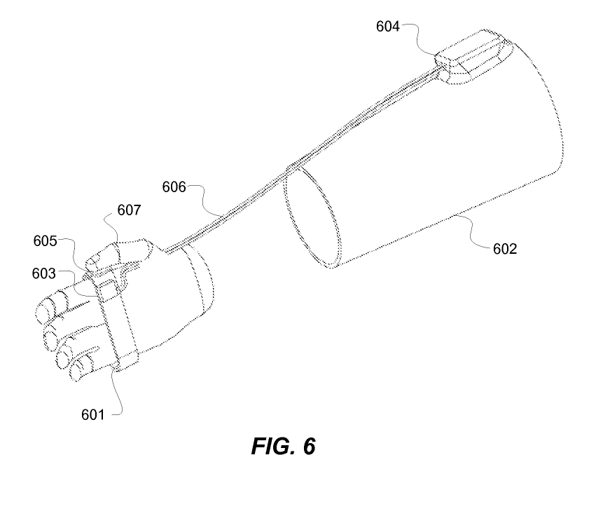

FIG. 6 illustrates a preferred embodiment of a hand-operated wireless controller. Waterproof trigger switch unit 603, incorporating a depressible trigger button 605, is securely positioned on the edge of the operator's hand near the thumb 607 by a fully or partially flexible hand strap 601. Hand strap 601 may comprise, for example, an elastic band attached at both ends Co aplastic mounting surface integrated with waterproof trigger switch unit 603, or an open-ended fabric band with patches of hook-and-loop fastening material ((for example, Velcro™) positioned at each end allowing band length adjustment to various hand sizes. An armband or wristband 602 around part of the operator's forearm or wrist incorporates a pocket or attachment for waterproof case 604, which contains at least one battery and a wireless transmitter (not visible, inside case 604). Power leads 606 are attached to arm-or-wrist-band 602 and routed to connect with waterproof trigger switch unit 603.

When the operator depresses trigger button 605 of waterproof trigger switch unit 603 with a movement of thumb 607, the wireless transmitter inside case 604 signals wireless receiver 401 in the ECU to activate the jet-pump propulsion system. Propulsion will continue as long as the trigger switch remains depressed. When trigger button 605 is released, the wireless transmitter inside case 604 signals wireless receiver 401 in the ECU to perform a “soft” incremental power-down lasting approximately 1-2 seconds, as previously described above, in order to avoid destabilizing the surfer with a sudden power-off. Advantageously, this thumb-operated one-handed wireless controller allows the surfer to control the jet-pump propulsion system without making any limb movements (e.g. reaching for controls with feet or hands) that would disrupt surfer's precise dynamic balance on the surfboard. This can be critically important for safety and the quality of the operator's experience.

In another embodiment of the wireless controller, a speed-selection control is included as well as the on-off trigger described above, to allow the operator to adjust motor power level to a preferred level. Such speed selection may be provided as a number of specific preset levels selectable by a switch, button array, or other suitable control attached to the surfer's body or clothing and connected to a wireless transmitter. For example, “3 km/h”, “6 km/h” and “9 km/h” settings may be provided. Alternatively, a continuous range of motor power levels may be available and selectable by operating a slider control, dial, knob, keypad, or other suitable “throttle” control. In these embodiments the interface circuit in the ECU may contain additional software for a microcontroller to interpret and execute the speed-setting commands.

In another embodiment, the wireless controller is integrated with the handle and shaft of a “stand-up paddle” to enable paddleboard surfers to control motorized versions of their boards. In such an embodiment, a cylindrical portion of the shaft or handgrip of the oar may be rotatable around the long axis of the shaft in order to function as a speed-setting control (for example, by providing “click” switch positions which are distinctly perceptible by touch). Analogous designs could be applied to oars, paddles, poles, and similar manual devices customarily used to propel a small watercraft by leverage against the water or reachable solid ground. Even windsurfers wanting to motor past leeward sides of wind-blocking obstacles, such as cliffs, could control the motor from a switch mounted on the boom.

Another embodiment of the wireless controller is adapted for use by a surfing instructor, where the instructor's wireless controller contains additional controls and selectable pre-programmed motor-power profiles to allow the instructor to remotely control an electric-powered motorized surfboard's speed and acceleration on “flat” water in ways that may simulate board behavior in surf, thereby enhancing effectiveness of instruction and practice sessions for the student riding the motorized surfboard. This type of controller could also be used by a lifeguard, harbormaster, or other guardian to assist an operator in difficulty.

To use the motorized surfboard system, the operator will take the assembled motorized surfboard to a suitable body of water (such as a seashore), install a fully-charged battery pack in the battery pack receptacle as described above, attach the hand-operated wireless controller unit to his or her hand and arm as described above, and enter the body of water with the motorized surfboard. The operator mounts or holds onto the board as in unpowered surfing, but may then use the wireless controller to activate the jet-pump propulsion system to propel the motorized surfboard to a preferred location. Upon committing to catch a specific incoming wave, the operator may again use the wireless controller to activate the jet-pump propulsion system in order to attain optimal takeoff position relative to the incoming wave, and to attain sufficient forward speed to successfully catch or “drop in” onto the wave face. If the operator executes a successful “drop in” and attains desired dynamic equilibrium on the moving wave face, he or she may then use the wireless controller to deactivate the jet-pump propulsion system (for example, by releasing the hand-operated wireless trigger switch described above in a preferred embodiment). In the course of normal surfing activity the operator may also find it desirable to activate the jet-pump propulsion system in other situations, such as escaping from hazardous or adverse locations in the surf zone, avoiding other surfers or watercraft, or returning to the shore. When the installed battery pack is nearing exhaustion, the operator may remove it as described above and install a fresh, fully-charged battery pack on shore (or in the water if associates or sponsors with watercraft are available to provide additional battery packs and retrieve used packs for recharging).

The motorized surfboard system with wearable wireless controller may also be used in “flat” water such as lakes, ponds, rivers, and swimming pools, where riders may use the system to learn basic surfing balance and weight-shifting skills or simply enjoy the experience of riding a water-jet propelled surfboard. Surfing instructors may also find the system useful as an aid to teaching fundamental surfing skills best practiced on a moving board in safe waters.

Many other embodiments, variations, and equivalents are implicit in, or may be extrapolated from, the foregoing description. These must be considered to be within the scope of the invention. Therefore, while the invention has been described in detail in its currently preferred embodiment, the foregoing disclosure does not limit the scope of the claims.

We claim:

1. A powered small watercraft, comprising:
a battery pack with seated terminals and casing preventing current leakage into ambient water;
a water-jet pump powered by the battery pack;
an electronic control unit powered by the battery pack and controlling the water-jet pump, comprising
a wireless receiver,
a programmable motor controller,
an information storage element with instructions for nuanced control of the water-jet pump,
a microprocessor interpreting signals received by the wireless receiver, reading the instructions on the information storage element, and issuing commands to the motor controller according to the instructions being read.
a body assembly comprising
a body of a size and shape similar to a conventional unpowered version of the watercraft, modified with cavities and channels fitting the battery pack, the water-jet pump, the electronic control unit, and associated electrical connections, and
a plurality of covers configured to confine and protect the battery pack, the water-jet pump, the electronic control unit, and the associated electrical connections inside the cavities and channels,
where
the cavities are configured to distribute the weight of intended contents so that the drag coefficient, balance, and center of gravity of the powered watercraft resembles those of a conventional unpowered version of the watercraft, and
when fully assembled, the shape of the powered watercraft substantially resembles that of a conventional unpowered version of the watercraft; and further comprising:
a wireless controller comprising
a switch,
a wireless transmitter controlled by the switch, and
a waterproof support structure supporting the switch and the wireless transmitter, where
the wireless transmitter communicates with the wireless receiver in the electronic control unit, and
the support structure positions the switch to be operable without disrupting an operator's normal postures and gestures conventionally associated with piloting the watercraft.

2. The watercraft of claim 1, where the battery pack is rechargeable.

3. The watercraft of claim 1, further comprising flotation elements built into the battery pack so that the battery pack floats in water when disengaged from the watercraft.

4. The watercraft of claim 1, further comprising a retaining fastener that disengages by hand, releasing the battery for swapping.

5. The watercraft of claim 4, where the retaining fastener disengages as a result of a handle being pulled out of a non-protruding operating position.

6. The watercraft of claim 5, where the retaining fastener comprises a spring-loaded locking pin that retracts fully from a mating receptacle when the handle is pulled.

7. The watercraft of claim 5, where the retaining fastener is spring-loaded by a spring-steel wire arc seated in a surface of the battery-pack casing.

8. The watercraft of claim 1, when the battery pack cavity opens toward a top surface of the watercraft.

9. The watercraft of claim 1, where the cavities in the body enable the water-jet pump and the battery pack installed on a fore-to-aft center plane of the watercraft.

10. The watercraft of claim 9, where the cavities in the body are arranged so that the jet-pump and the electronics control unit is installed on a fore-to-aft center plane of the watercraft.

11. The watercraft of claim 1, further comprising an air-vent tube connecting an operating apex of the water-jet-pump cavity to the ambient air during operation.

12. The watercraft of claim 11, where the water-jet pump cavity is curved to follow the shape of the pump and tapered to guide water past the impeller and motor while guiding air bubbles toward the air-vent tube.

13. The watercraft of claim 1, where heat-generating and heat-sensitive elements of the electronic control unit are attached in thermal contact with a heat-dissipating cover on the bottom of the body assembly so that ambient water further dissipates heat from the cover.

14. The watercraft of claim 1, where at least one of the cavities in the body is lined by a solid box, receptacle, or shroud having a perimeter flange similar to the flange of a fin box.

15. The watercraft of claim 1, where the conventional unpowered version of the watercraft is a surfboard.

16. A wireless control system for an electric motor powering a small balance-sensitive watercraft, comprising:
an electronic control unit mounted to the watercraft, comprising
a wireless receiver,
an information-storage element with stored instructions for controlling the electric motor,
a microprocessor in communication with the wireless receiver and the information-storage element, and
a motor controller controlling the electric motor according to instructions from the microprocessor,
and further comprising a primary wireless transmitter communicating with the wireless receiver and responsive to an operator's manipulation of a switch,
where the stored instructions comprise an instruction to activate the motor and an instruction to gradually ramp down motor power to zero to prevent a sudden stop.

17. The control system of claim 16, further comprising a secondary wireless transmitter in communication with the wireless receiver, the second wireless transmitter used by a person located away from the watercraft to assist the watercraft operator.

18. The control system of claim 17, further comprising stored instructions for power/time sequences capable of initiation by the second wireless transmitter and optimized for at least one of instruction, demonstration, rescue, and hazard avoidance.

19. The control system of claim 16, where the motor controller automatically executes a power ramp-down if the operator ceases actively requesting continued motor power by holding the switch in an “on” position.

20. The control system of claim 16, where
the watercraft is a surfboard,
the switch is worn on the operator's hand, and
the switch is operable by the thumb or fingers of the same hand from a wide range of expected body positions.

21. The control system of claim 16, where
the watercraft is customarily propelled or steered by an implement held in the operator's hand, and
the switch is integrated in the implement near the normal operating position of at least one of the operator's hands.

22. The control system of claim 16, further comprising stored instructions for motor power variations other than fill-power and ramp-down, where the switch is configured to issue corresponding distinguishable commands.

23. The control system of claim 16, further comprising a heat dissipater conducting heat away from the electronic control unit and into surrounding water.

24. The control system of claim 16, further comprising a data interface through which additional instructions can be downloaded into the storage element and additional functions can be programmed into the microprocessor from an external device.

25. The control system of claim 24, where the external device is selected from the following group: computers, portable phones, miniature digital storage-and-playback devices, and electronic organizers.

26. The control system of claim 24, further comprising:
a data-logging function programmed into the microprocessor,
associated sensors to collect data for logging, and
instructions for uploading the data to an external device.

27. The control system of claim 26, further comprising a real-time indicator mounted on the watercraft in a location visible to the operator during operation, displaying a selected subset of the data as it is collected.

28. The control system of claim 27, where the location visible to the operator is on an exposed surface of a battery pack and the selected subset of data comprises an amount of charge presently remaining in the battery.
